(19) United States
(12) Patent Application Publication
(10) Pub. No.: US 2010/0001908 A1
(43) Pub. Date: Jan. 7, 2010

(54) Digital Television Antenna

(75) Inventor: Yen-Yu Chen, Chung Ho City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AVERMEDIA TECHNOLOGIES, INC., Chung Ho City (TW)

(21) Appl. No.: 12/358,478

(22) Filed: Jan. 23, 2009

(30) Foreign Application Priority Data
Jul. 1, 2008 (TW) 97124739

(51) Int. Cl. H01Q 1/38

(52) U.S. Cl. 343/700 MS

(57) ABSTRACT

A digital television antenna built in a portable device. The portable device has a system ground board. The digital television antenna includes a parasitic arm and a signal feeding arm. The parasitic arm has a ground point and at least one bending portion. The shape of the parasitic arm is a step-like form. The ground point of the parasitic arm touches the system ground board of the portable device. The signal feeding arm has a main portion and a feeding terminal for receiving a digital television signal with a frequency from 470 MHz to 870 MHz. The shape of the main portion is approximate to a rectangle.

### RELATED APPLICATIONS

This application claims priority to Taiwan Application Serial Number 97124739, filed Jul. 1, 2008, which is herein incorporated by reference.

### BACKGROUND

1. Field of Invention

The present invention relates to an antenna apparatus. More particularly, the present invention relates to a digital television antenna for a portable device.

2. Description of Related Art

The key development in communication technology has been the transfer from wired to wireless communication. In the field of wireless communication, the signal propagates through the air in the form of an electromagnetic wave, where the bridge of the signals between the wireless device and the air is an antenna.

Because the operation frequency of the digital television (DTV) is between 470 MHz to 870 MHz, the conventional DTV antenna is usually attached to the exterior of the device. A variety of problems are inherent to this arrangement, however. For example, external forces easily damage such an antenna, the overhead of the circuit design is increased and the device is harder to carry. For these reasons, the external antenna is increasingly unsuited for use in advanced wireless communication devices.

Therefore, it is apparent that the DTV antenna built in portable devices will be a mainstream trend in the communications field.

### SUMMARY

An embodiment of the invention provides a digital television antenna built in a portable device. The portable device has a system ground board. The digital television antenna includes a parasitic arm and a signal feeding arm. The parasitic arm has a ground point and at least one bending portion. The shape of the parasitic arm is a step-like form. The ground point of the parasitic arm touches the system ground board of the portable device. The signal feeding arm has a main portion and a feeding terminal for receiving a digital television signal with a frequency from 470 MHz to 870 MHz. The shape of the main portion is approximate to a rectangle.

Another embodiment of the invention provides a digital television antenna built in a portable device. The portable device has a system ground board. The digital television antenna includes a nonconductive substrate, a parasitic arm, and a signal feeding arm. The parasitic arm has a ground point and at least one bending portion. The parasitic arm and the signal feeding arm are formed on the nonconductive substrate. The shape of the parasitic arm is a step-like form. The ground point of the parasitic arm touches the system ground board of the portable device. The signal feeding arm has a main portion and a feeding terminal for receiving a digital television signal with a frequency from 470 MHz to 870 MHz. The shape of the main portion is approximate to a rectangle.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of a first embodiment of the digital television antenna of the invention;

FIG. 2 illustrates a test chart of return loss for the digital television antenna of the present invention;

FIG. 3 illustrates a test chart of the efficiency of the first embodiment of the invention;

FIG. 4 illustrates a schematic diagram of a second embodiment of the digital television antenna of the invention;

FIG. 5 illustrates a schematic diagram of a third embodiment of the digital television antenna of the invention; and

FIG. 6 illustrates a schematic diagram of a fourth embodiment of the digital television antenna of the invention.

FIG. 7 illustrates a schematic diagram of a fifth embodiment of the digital television antenna of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention provides a digital television antenna, which can be built in a casing of a potable device to receive a digital television signal with a frequency from 470 MHz to 870 MHz. The portable device can be a laptop computer, a mini computer, or other portable devices with digital television receiving function.

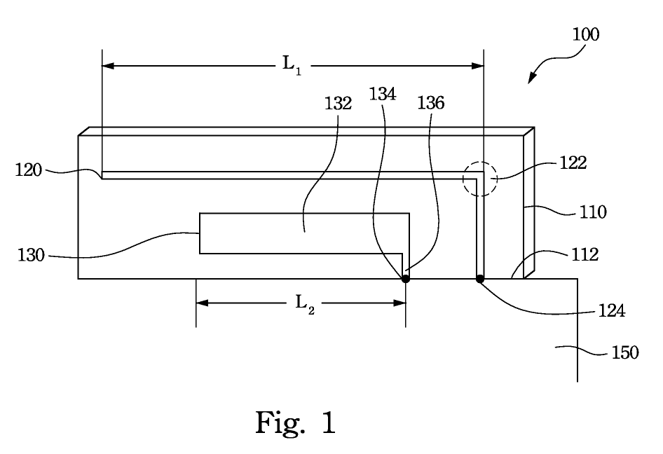

Refer to FIG. 1. FIG. 1 illustrates a schematic diagram of a first embodiment of the digital television antenna of the invention. The digital television antenna 100 is built in the portable device. The digital television antenna 100 includes a nonconductive substrate 110, a parasitic arm 120, and a signal feeding arm 130. The parasitic arm 120 and the signal feeding arm 130 are formed on the nonconductive substrate 110. The portable device has a system ground board 150. The digital television antenna 100 can use the system ground board 150 for grounding. For example, the portable device can be a laptop computer, and the system ground board 150 can be the ground board disposed behind a liquid display panel.

The nonconductive substrate 110 has a first edge 112 neighboring the system ground board 150. The signal feeding arm 130 is disposed between the parasitic arm 120 and the first edge 112. The parasitic arm 120 has a bending portion 122, and the shape of the parasitic arm 120 is approximate to an inverted-L. The bending portion 122 does not touch the first edge 112. The parasitic arm 120 has a ground point 124. The ground point 124 is disposed on the first edge 112, and the ground point 124 of the parasitic arm 120 touches the system board 150 for grounding.

The signal feeding arm 130 has a main portion 132 and a feeding terminal 134. The shape of the main portion 132 is approximate to a rectangle. The main portion 132 does not touch the first edge 112. The signal feeding arm 130 further includes an extending portion 136 extended from the main portion 130 toward the system ground board 150. The feeding terminal 134 is disposed on the extending portion 136. The shape of the signal feeding arm 130 is approximate to an inverted-L.

The signal feeding arm 130 and the parasitic arm 120 are disposed on the same side of the nonconductive substrate 110. The signal feeding arm 130 and the parasitic arm 120 are disposed on the same plane. The parasitic arm 120 and the signal feeding arm 130 can be formed on the nonconductive substrate 110 by a printing or an etching process. The expanding length L₁ of the parasitic arm 120 is longer than the expending length L₂ of the signal feeding arm 130. The corresponding wavelength of the parasitic arm 130 is ¼, and the center frequency of the parasitic arm 130 is 600 MHz.

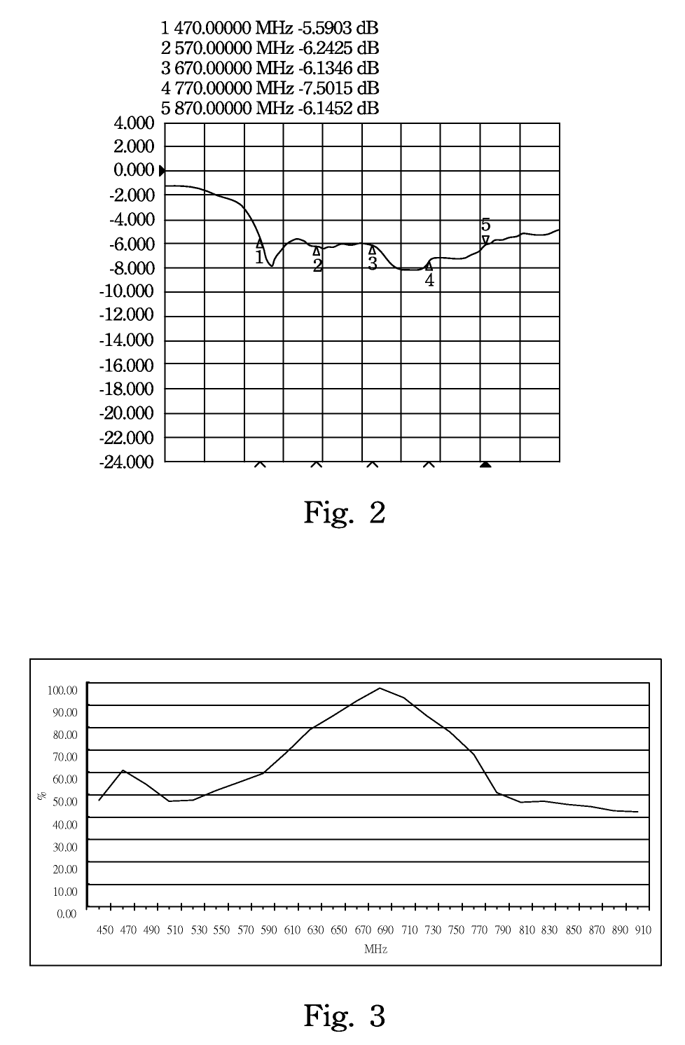

Refer to FIG. 2. FIG. 2 illustrates a test chart of return loss for the digital television antenna of the present invention. The size of the digital television antenna 100 for test is described in the following. The length is 300 mm and the width is 250 mm of the system ground board 150. The length is 50.5 mm and the width is 10 mm of the signal feeding arm 130. A rectangular slice whose length is 64 mm and width is 12.5 mm is severed from a metal slice whose length is 64 mm and width is 13 mm to form the parasitic arm 120, and the ground terminal 134 is electrically connected to the system ground board 150.

The digital television antenna 100 in this invention is utilized for receiving the digital television signal with a frequency from 470 MHz to 870 MHz. According to the experimental data, the impedance bandwidth of this embodiment is less than −6 dB when the digital television antenna 100 receives the digital television signal with a frequency from 470 MHz to 870 MHz. Namely, the digital television antenna 100 can be regarded to have a good radiation characteristic.

Refer to FIG. 3. FIG. 3 illustrates a test chart of the efficiency of the first embodiment of the invention. The digital television antenna 100 is utilized for receiving the digital television signal with a frequency from 470 MHz to 870 MHz. According to the experimental data, the efficiency of this embodiment keeps mostly higher than 50% when the digital television antenna 100 receives the digital television signal with a frequency from 470 MHz to 870 MHz. Namely, the digital television antenna 100 can be regarded to have a good working efficiency.

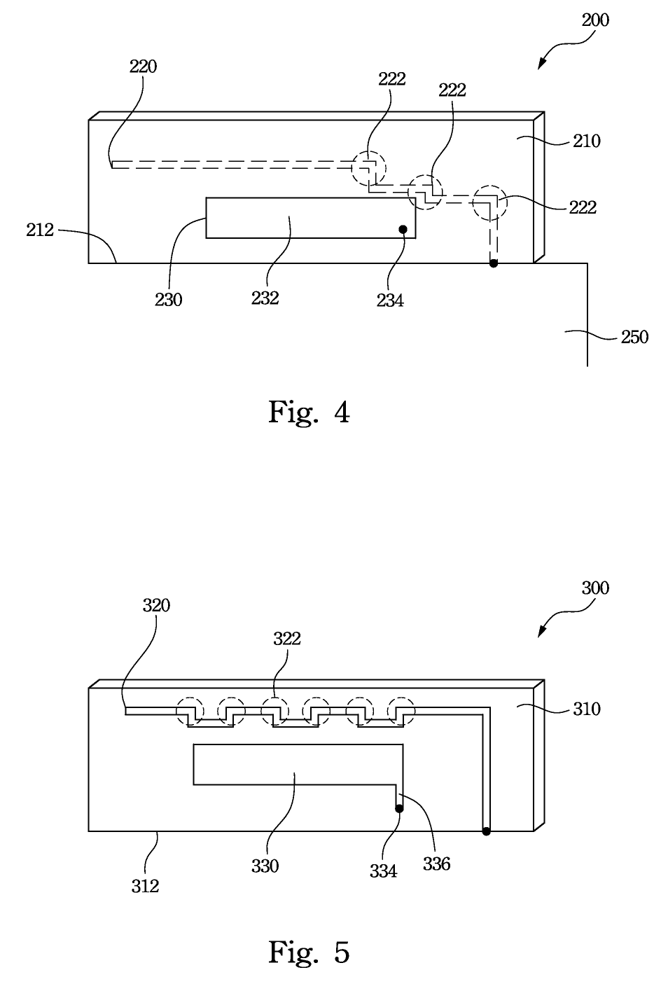

Refer to FIG. 4. FIG. 4 illustrates a schematic diagram of a second embodiment of the digital television antenna of the invention. The digital television antenna 200 is built in a potable device for receiving a digital television signal with a frequency from 470 MHz to 870 MHz. The parasitic arm 220 and the signal feeding arm 230 are formed on two opposite sides of the nonconductive substrate 210 in this embodiment. The signal feeding arm 230 is disposed next to the system ground board 250. The signal feeding arm 230 is arranged between the parasitic arm 220 and the system ground board 250. The signal feeding arm 230 does not touch the first edge 212. The shape of the main portion 232 of the signal feeding arm 230 is approximate to a rectangle. The feeding terminal 234 is placed on the main portion 232. The parasitic arm 220 has plural bending portions 222, and the shape of the parasitic arm 220 is a step-like form.

Refer to FIG. 5. FIG. 5 illustrates a schematic diagram of a third embodiment of the digital television antenna of the invention. The digital television antenna 300 is built in a portable device for receiving a digital television signal with a frequency from 470 MHz to 870 MHz. The parasitic arm 320 and the signal feeding arm 330 of the digital television antenna 300 are formed on the same side of the nonconductive substrate 310. The parasitic arm 320 has plural bending portions 322. The bending portions 322 are linear arranged, and the shape of the parasitic arm 320 is approximate to an inverted-L. The extending portion 336 of the signal feeding arm 330 is extend toward the first edge 312, and the feeding terminal 334 is disposed on the extending portion 336. The feeding terminal 334 does not touch the first edge 312 in this embodiment.

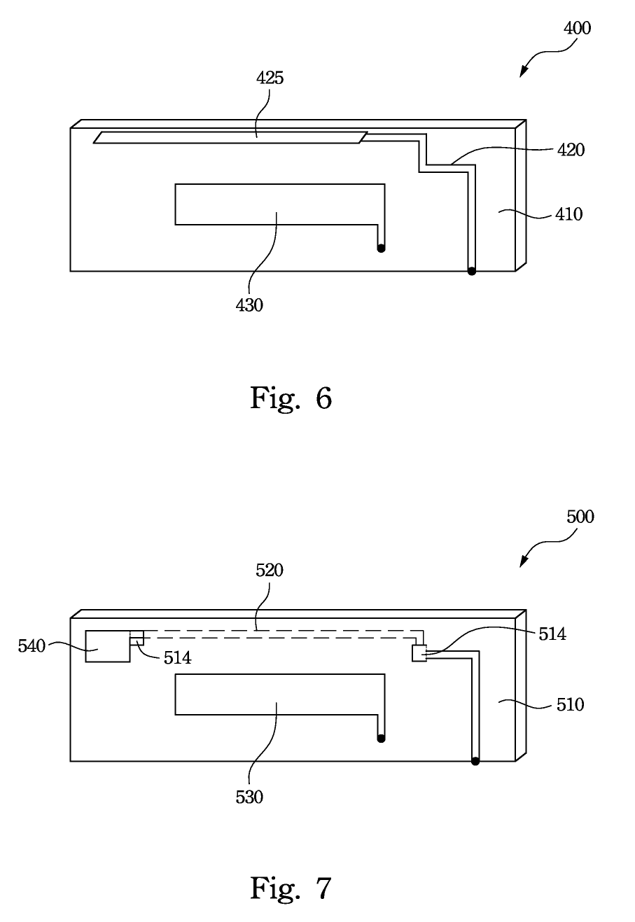

Refer to FIG. 6. FIG. 6 illustrates a schematic diagram of a fourth embodiment of the digital television antenna of the invention. The digital television antenna 400 is built in a portable device for receiving a digital television signal with a frequency from 470 MHz to 870 MHz. The digital television antenna 400 in this embodiment is a solid structure to reduce the space in the portable device. The parasitic arm 420 and the signal feeding arm 430 are formed on the same side of the nonconductive substrate 410. The parasitic arm 420 and the signal feeding arm 430 are not disposed on the same plane. A part of the parasitic arm 425 is bent and become vertical to the signal feeding arm 430.

Refer to FIG. 7. FIG. 7 illustrates a schematic diagram of a fifth embodiment of the digital television antenna of the invention. The nonconductive substrate 510 has plural through holes 514, and the parasitic arm 520 formed on the nonconductive substrate 510 can penetrate the through holes 514. Thus a part of the parasitic arm 520 is disposed at the same side with the signal feeding arm 530, and another part of the parasitic arm 520 is disposed at the opposite side to the signal feeding arm 530. The expending length of the parasitic arm 520 is longer than the expending length of the signal feeding arm 530. The parasitic arm 520 can further include a support arm 540 to improve the receiving efficiency of the digital television antenna 500.

The digital television antenna is built in a portable device for receiving a digital television signal with a frequency from 470 MHz to 870 MHz. The parasitic arm and the signal feeding arm of the digital television antenna can be formed on the same side or two opposite sides of the nonconductive substrate. The parasitic arm and the signal feeding arm can be disposed on the same plane. The digital television antenna can be a solid structure to reduce the space of the digital television antenna in the portable device. The parasitic arm can have at least one bending portion, and the shape of the parasitic arm is a step-like form.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A digital television antenna built in a portable device, wherein the portable device has a system ground board, the digital television antenna comprising:
a parasitic arm having a ground point and at least one bending portion, wherein a shape of the parasitic arm is a step-like form, and the ground point of the parasitic arm touches the system ground board of the portable device; and
a signal feeding arm having a main portion and a feeding terminal for receiving a digital television signal with a frequency from 470 MHz to 870 MHz, wherein the shape of the main portion is approximate to a rectangle.

2. The digital television antenna of claim 1, wherein the signal feeding arm and the parasitic arm are disposed on the same plane, and the signal feeding arm is disposed between the system ground board and the parasitic arm.

3. The digital television antenna of claim 1, wherein the signal feeding arm and the parasitic arm are not disposed on the same plane.

4. The digital television antenna of claim 3, wherein a part of the parasitic arm is bent to be vertical to the signal feeding arm.

5. The digital television antenna of claim 1, wherein an expanding length of the parasitic arm is longer than an expanding length of the signal feeding arm.

6. A digital television antenna built in a portable device, wherein the portable device has a system ground board, the digital television antenna comprising:
a nonconductive substrate;
a parasitic arm formed on the nonconductive substrate and having a ground point and at least one bending portion, wherein a shape of the parasitic arm is a step-like form, and the ground point of the parasitic arm touches the system ground board of the portable device; and
a signal feeding arm formed on the nonconductive substrate and having a main portion and a feeding terminal for receiving a digital television signal with a frequency from 470 MHz to 870 MHz, wherein the shape of the main portion is approximate to a rectangle.

7. The digital television antenna of claim 6, wherein the signal feeding arm and the parasitic arm are formed on the same side of the nonconductive substrate, and the signal feeding arm is disposed between the system ground board and the parasitic arm.

8. The digital television antenna of claim 6, wherein the signal feeding arm and the parasitic arm are formed on opposite sides of the nonconductive substrate respectively.

9. The digital television antenna of claim 6, wherein the nonconductive substrate has a plurality of through holes, and the parasitic arm penetrates through the through holes.

10. The digital television antenna of claim 6, wherein the signal feeding arm and the parasitic arm are disposed on the same plane, and the signal feeding arm is disposed between the system ground board and the parasitic arm.

11. The digital television antenna of claim 6, wherein the signal feeding arm and the parasitic arm are not disposed on the same plane.

12. The digital television antenna of claim 11, wherein a part of the parasitic arm is bent to be vertical to the signal feeding arm.

13. The digital television antenna of claim 6, wherein an expanding length of the parasitic arm is longer than an expanding length of the signal feeding arm.

14. A digital television antenna built in a portable device, wherein the portable device has a system ground board, the digital television antenna comprising:
a nonconductive substrate having a first edge neighboring the system ground board;
a parasitic arm formed on the nonconductive substrate, comprising:
a ground point disposed on the first edge and touching the system ground board of the portable device, and
at least one bending portion, wherein a shape of the parasitic arm is a step-like form, and the bending portion does not touch the first edge; and
a signal feeding arm formed on the nonconductive substrate and having a main portion and a feeding terminal for receiving a digital television signal with a frequency from 470 MHz to 870 MHz, wherein the shape of the main portion is approximate to a rectangle, and the main portion does not touch the first edge.

15. The digital television antenna of claim 14, wherein the signal feeding arm and the parasitic arm are formed on the same side of the nonconductive substrate, and the signal feeding arm is disposed between the system ground board and the parasitic arm.

16. The digital television antenna of claim 14, wherein the signal feeding arm and the parasitic arm are formed on opposite sides of the nonconductive substrate respectively.

17. The digital television antenna of claim 14, wherein the nonconductive substrate has a plurality of through holes, and the parasitic arm penetrates through the through holes.

18. The digital television antenna of claim 14, wherein the signal feeding arm and the parasitic arm are disposed on the same plane, and the signal feeding arm is disposed between the system ground board and the parasitic arm.

19. The digital television antenna of claim 14, wherein the signal feeding arm and the parasitic arm are not disposed on the same plane.

20. The digital television antenna of claim 14, wherein a part of the parasitic arm is bent to be vertical to the signal feeding arm.
